(19) United States
(12) Patent Application Publication
(10) Pub. No.: US 2008/0158151 A1
(43) Pub. Date: Jul. 3, 2008

(54) Electronic devices and input methods therefor

(75) Inventors: Yi-Shen Wang, Taoyuan (TW); Hsi-Kun Chen, Taoyuan (TW); Te-Chuan Liu, Taoyuan (TW)

Correspondence Address: BIRCH STEWART KOLASCH & BIRCH, PO BOX 747, FALLS CHURCH, VA, 22040-0747, US

(73) Assignee: High Tech Computer Corp.

(21) Appl. No.: 12/003,365

(22) Filed: Dec. 21, 2007

(30) Foreign Application Priority Data
Dec. 29, 2006 (TW) 95149886

(51) Int. Cl. G09G 5/00

(52) U.S. Cl. 345/156; 178/18.01

(57) ABSTRACT

An input method is used for an electronic device having a touch-sensitive element and a display unit. Firstly, a contact on a specific zone of the touch-sensitive element is detected. Then, it is determined whether the contact remains. When the contact remains and slides to a specific position of the touch-sensitive element, a specific number corresponding to the specific zone is selected for input.

### BACKGROUND OF THE INVENTION

1. Field of the Invention

The disclosure relates generally to electronic devices and input methods therefor, and, more particularly to electronic devices using a touch-sensitive element for input and input methods therefor.

2. Description of the Related Art

Recently, portable devices, particularly handheld devices, have become more and more advanced and multi-functional. For example, a handheld device may provide email access, advanced address book management, media playback, and various other applications. With the convenience of the functions and devices, handheld devices have become important tools for everyday life.

Some conventional handheld devices are provided with touch-sensitive elements, e.g. rotational and/or vertical input elements, for user to operate the devices. For example, FIGS. 1A and 1B show handheld devices having a vertical input element 110 and a rotational input element 120, respectively. Users can highlight and select menu items by sliding their finger along the surface of the input elements in up and down or circular motions.

In addition, telecommunication capability is generally one of main desired functions provided in handheld devices such as PDAs (Personal Digital Assistants), smart phones, GPS (Global Positioning System) devices, or mobile phones. However, if a handheld device provided with a touch-sensitive element has a dialing keypad 200 (as shown in FIG. 2) for making calls, the surface and size of the handheld device would increase considerably, and the front layout consisting of the touch-sensitive element, the dialing keypad and a display would thus become very cluttered. Therefore, in order to meet the requirement that handheld devices are designed with more complex and diverse functions, there is a need for handheld devices to incorporate various input elements, thereby increasing flexibility for device design and operation.

### BRIEF SUMMARY OF THE INVENTION

The present invention provides electronic devices and input methods therefor.

In one embodiment, an input method of the present invention is used for an electronic device having a touch-sensitive element and a display unit and comprises the following steps. Firstly, a contact on a specific zone of the touch-sensitive element is detected. Then, it is determined whether the contact remains. If the contact remains and slides to a specific position on the touch-sensitive element, a specific number corresponding to the specific zone is selected for input.

In other embodiment, an input method of the present invention is for use in an electronic device having a touch-sensitive element and a display unit and comprises the following steps. Firstly, a contact on the touch-sensitive element is detected. Then, it is determined whether the contact remains. If the contact remains and slides for a specific distance, a specific number corresponding to the specific distance is selected for input.

In one embodiment, an electronic device of the present invention comprises a display unit and a touch-sensitive element. The display unit displays a plurality of numbers. The touch-sensitive element has a touch-sensitive surface. The touch-sensitive surface defines a plurality of specific zones and a specific position, where each specific zone corresponds to one of the numbers. When a contact occurs on one of the specific zones and slides to the specific position, the display unit highlights the number corresponding to the specific zone with the occurrence of the contact.

In other embodiment, an electronic device of the present invention comprises a display unit and a touch-sensitive element. The display unit displays a plurality of numbers. The touch-sensitive element has a touch-sensitive surface. When a contact occurs on the touch-sensitive surface and slides for a specific distance, the display unit highlights one of the numbers according to the specific distance.

The input methods of the present invention may take the form of a program code embodied in a tangible media. When the program code is loaded into and executed by a device, the device is capable of practicing the disclosed method.

### BRIEF DESCRIPTION OF THE DRAWINGS

The invention will become more fully understood by referring to the following detailed description with reference to the accompanying drawings, wherein:

FIGS. 1A and 1B are schematic diagrams of handheld devices having a vertical input element and a rotational input element, respectively;

FIG. 2 shows a conventional dialing keypad;

FIG. 3 is a schematic diagram of a portable device according to one embodiment of the present invention;

FIG. 4 is a schematic diagram of a graphic interface corresponding to the touch-sensitive element shown in FIG. 3;

FIGS. 5A and 5B are schematic diagrams of a portable device according to other embodiment of the present invention;

FIG. 6A is a schematic diagram of a rotational touch-sensitive element, which comprises specific zones and a specific position, according to one embodiment of the present invention;

FIG. 6B is a schematic diagram of a vertical touch-sensitive element, which comprises specific zones and a specific position, according to other embodiment of the present invention;

FIG. 7 is a flowchart for illustrating an input method according to one embodiment of the present invention;

FIG. 8A shows a schematic diagram of a rotational touch-sensitive element for illustrating an input operation according to one embodiment of the present invention;

FIG. 8B shows a schematic diagram of a graphic interface for illustrating the input result corresponding to the operation of the touch-sensitive element shown in FIG. 8A;

FIGS. 9A to 9G shows schematic diagrams of graphic interfaces for illustrating the input operation of the touch-sensitive element shown in FIG. 8A;

FIG. 10A shows a schematic diagram of a rotational touch-sensitive element for illustrating an input operation according to other embodiment of the present invention;

FIG. 10B shows a schematic diagram of a graphic interface for illustrating the input result corresponding to the operation of the touch-sensitive element shown in FIG. 10A;

FIG. 11A shows a schematic diagram of a vertical touch-sensitive element for illustrating an input operation according to one embodiment of the present invention;

FIG. 11B shows a schematic diagram of a vertical touch-sensitive element for illustrating an input operation according to other embodiment of the present invention;

FIG. 12 is a flowchart for illustrating an input method according to other embodiment of the present invention;

FIG. 13A shows a schematic diagram of a rotational touch-sensitive element according to one embodiment of the present invention for illustrating a relationship between a sliding distance and a specific number;

FIG. 13B shows a schematic diagram of a vertical touch-sensitive element according to other embodiment of the present invention for illustrating a relationship between a sliding distance and a specific number;

FIG. 14A shows a schematic diagram of a rotational touch-sensitive element for illustrating an input operation according to other embodiment of the present invention;

FIG. 14B shows a schematic diagram of a rotational touch-sensitive element for illustrating an input operation according to other embodiment of the present invention;

FIG. 15A shows a schematic diagram of a vertical touch-sensitive element for illustrating an input operation according to other embodiment of the present invention; and

FIG. 15B shows a schematic diagram of a vertical touch-sensitive element for illustrating an input operation according to other embodiment of the present invention.

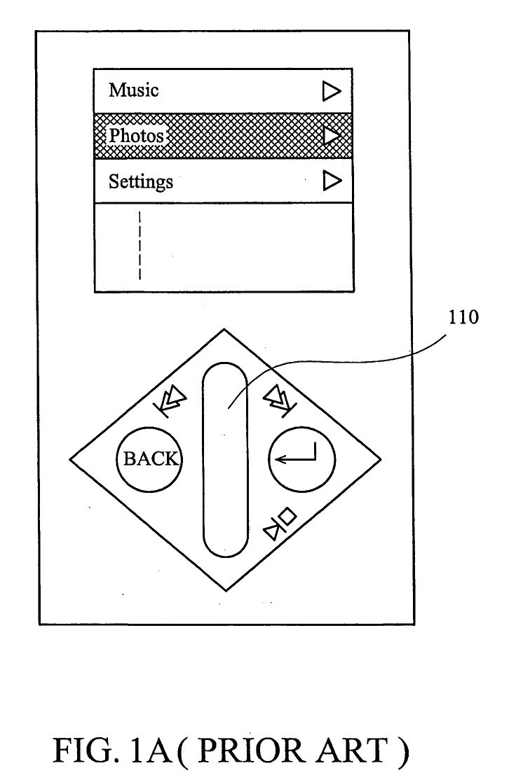

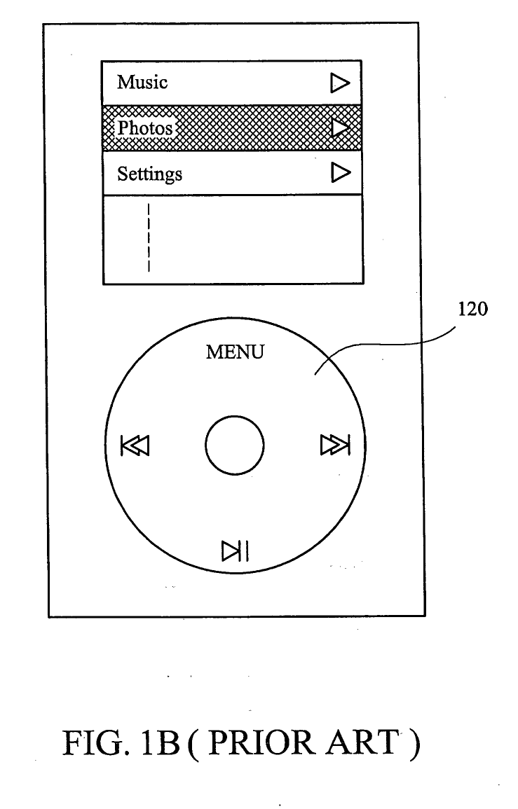

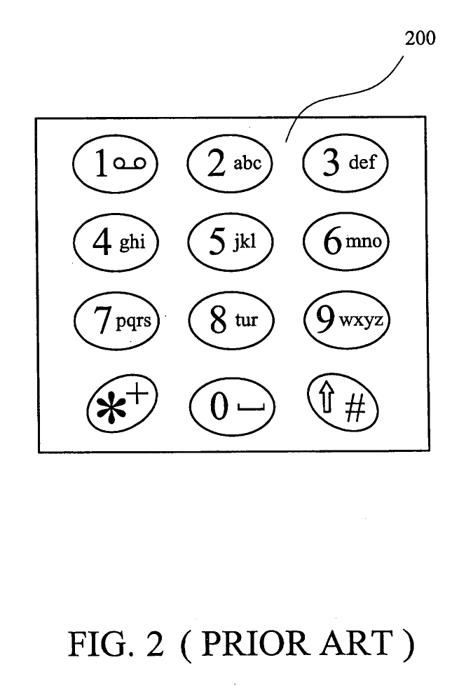

### DETAILED DESCRIPTION OF THE INVENTION

Input methods and electronic devices thereof are provided.

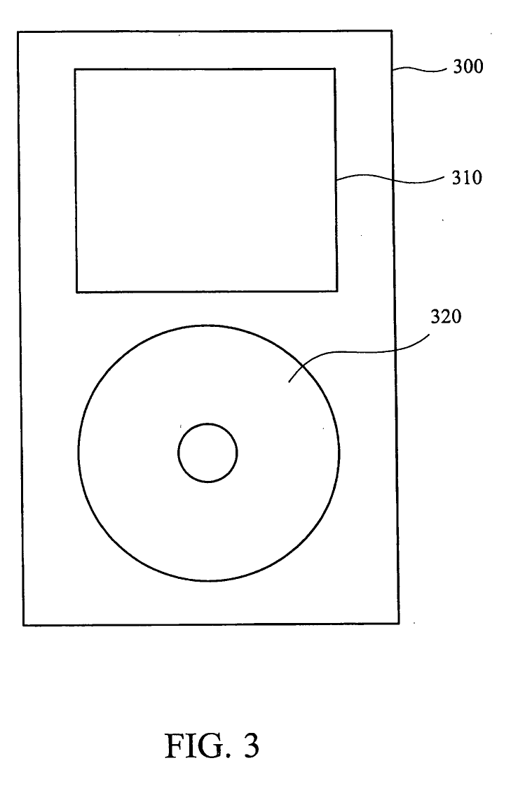

FIG. 3 is a schematic diagram of a portable device according to one embodiment of the present invention.

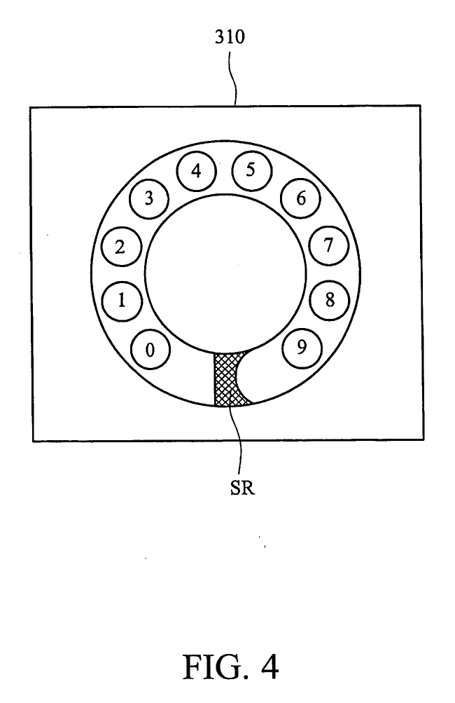

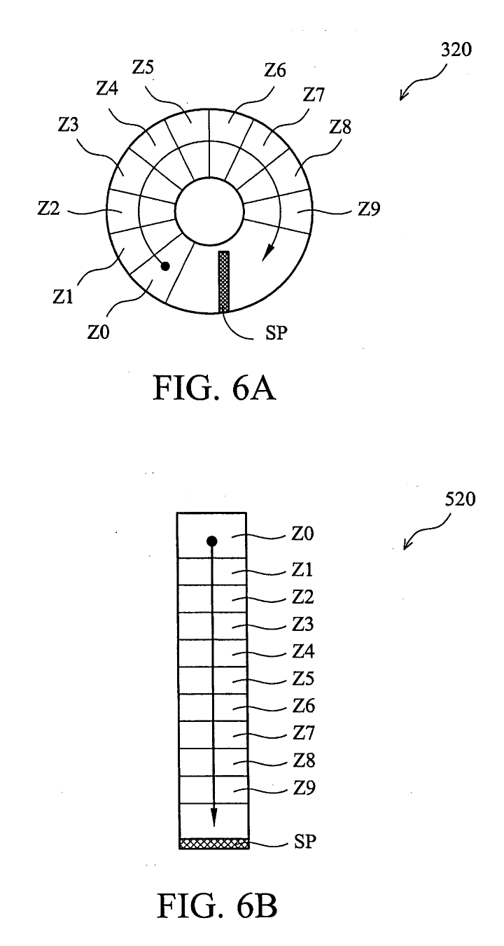

The portable device 300 may be a handheld device such as a PDA, a smart phone, a GPS device, a mobile phone, and others. A display unit 310 and a touch-sensitive element 320 are provided on the front of the portable device 300. The touch-sensitive element 320 may be a rotational input element having a circular touch-sensitive surface. It is noted that, in some embodiments, the touch-sensitive element 320 can be physically or logically divided into a plurality of specific zones and a specific position. A graphic interface corresponding to the touch-sensitive element 320 can be displayed on the display unit 310 of the portable device 300, such as a dialing interface shown in FIG. 4. In the graphic interface, numbers 0 to 9 are arranged along a specific route, such as an arc route, in sequence. FIG. 6A is a schematic diagram of a rotational touch-sensitive element, which comprises specific zones and a specific position, according to one embodiment of the present invention. In this embodiment, the touch-sensitive element 320 has zones Z0, Z1, Z2, Z3, Z4, Z5, Z6, Z7, Z8 and Z9, respectively corresponding to numbers 0, 1, 2, 3, 4, 5, 6, 7, 8 and 9 in the dialing interface shown in FIG. 4. Additionally, the touch-sensitive element 320 defines a specific position (SP) corresponding to a positional notation (SR) in the dialing interface in FIG. 4.

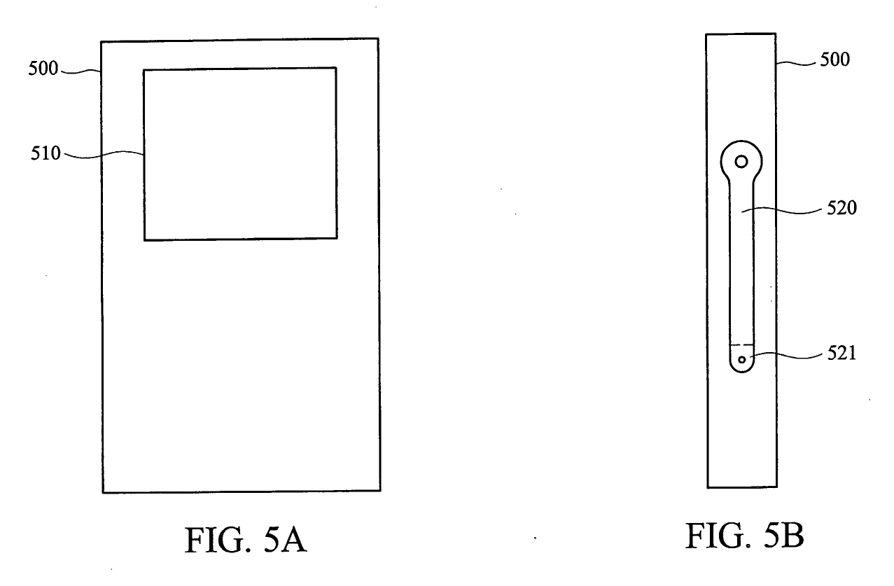

FIGS. 5A and 5B are schematic diagrams of a portable device according to other embodiment of the present invention.

The portable device 500 may be a handheld device such as a PDA (Personal Digital Assistant), a smart phone, a GPS (Global Positioning System) device, a mobile phone, and others. A display unit 510 is provided on the front side of the portable device 500, and a touch-sensitive element 520 is provided on the side of the portable device 500. A graphic interface corresponding to the touch-sensitive element 520 can be displayed on the display unit 510, as shown in FIG. 4. The touch-sensitive element 520 may be a vertical input element having an elongated touch-sensitive surface. In some embodiments, the touch-sensitive element 520 can be physically or logically divided into a plurality of specific zones and a specific position 521. It is noted that, in this embodiment, the specific position 521 is located at the lower end of the elongated touch-sensitive surface. In some embodiments, the specific position may be located at the upper end of the elongated touch-sensitive surface. Further, in some embodiments, two specific positions may be respectively located at two ends of the elongated touch-sensitive surface. FIG. 6B is a schematic diagram of a vertical touch-sensitive element, which comprises specific zones and a specific position, according to other embodiment of the present invention. Similarly, in this embodiment, the touch-sensitive element 520 has zones Z0, Z1, Z2, Z3, Z4, Z5, Z6, Z7, Z8 and Z9, respectively corresponding to numbers 0, 1, 2, 3, 4, 5, 6, 7, 8 and 9 in the dialing interface in FIG. 4. Additionally, the touch-sensitive element 520 defines a specific position (SP) corresponding to the positional notation (SR) in the dialing interface in FIG. 4.

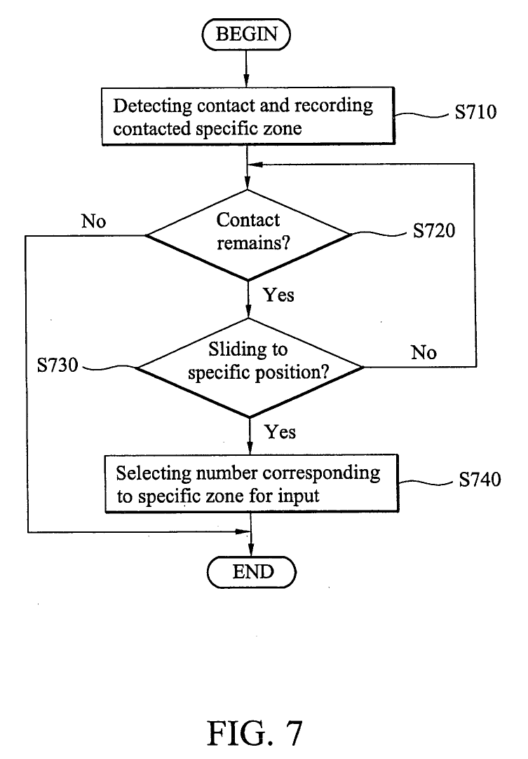

FIG. 7 is a flowchart for illustrating an input method according to one embodiment of the present invention. In this embodiment, the touch-sensitive element is physically or logically divided into a plurality of zones and a specific position. Each zone corresponds to a specific number. Users can use a pointer such as finger or stylus to contact one of the zones of the touch-sensitive element, and slide to the specific position of the touch-sensitive element, thus selecting a number corresponding to the contacted zone for input.

Firstly, in step S710, a contact of a pointer such as finger or stylus on the touch-sensitive element is detected, and a specific zone contacted by the pointer is recorded. It is noted that the detection of a pointer contact may be triggered by contacting any position of the touch-sensitive element or contacting any position of the touch-sensitive element for a predetermined period. In some embodiments, the display unit can display a graphic interface corresponding to the touch-sensitive element, as shown in FIG. 4.

In step S720, it is determined whether the contact of the pointer remains on the surface of the touch-sensitive element. If the contact does not remain, that is, if the pointer leaves the surface of the touch-sensitive element, the input procedure ends. If the contact remains, it is determined whether the pointer slides to the specific position of the touch-sensitive element in step S730. If the pointer does not slide to the specific position, the input procedure returns to step S720. If the pointer slides to the specific position, a number corresponding to the specific zone initially contacted by the pointer is selected from the numbers for input in step S740.

It is understood that, in some embodiments, after the pointer slides from the specific zone to the specific position, that is after a number corresponding to the specific zone is selected, the pointer can stop contacting the touch-sensitive element or leave the surface of the touch-sensitive element. After the pointer leaves the surface of the touch-sensitive element, the selected number is input and highlighted on the display unit. In some embodiments, when the contact of the pointer remains and slides to the specific position of the touch-sensitive element, the number corresponding to the specific zone can be displayed on the display unit; afterward, when the pointer leaves the surface of the touch-sensitive element, the selected number is then input. Additionally, when the contact of the pointer remains and slides on the touch-sensitive element, the graphic interface on the display unit can rotate according to the sliding direction of the contact. For example, numbers 0 to 9 are arranged along a specific route, such as an arc route shown in FIG. 4, in sequence. When the contact remains and slides, the numbers displayed on the display unit move along the arc route according to the sliding direction of the contact.

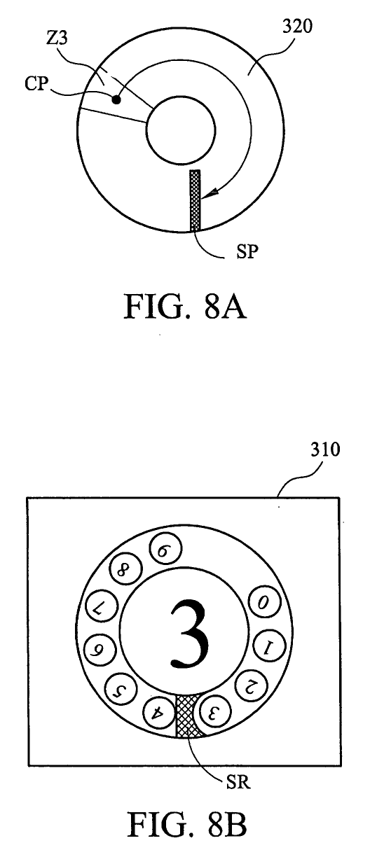

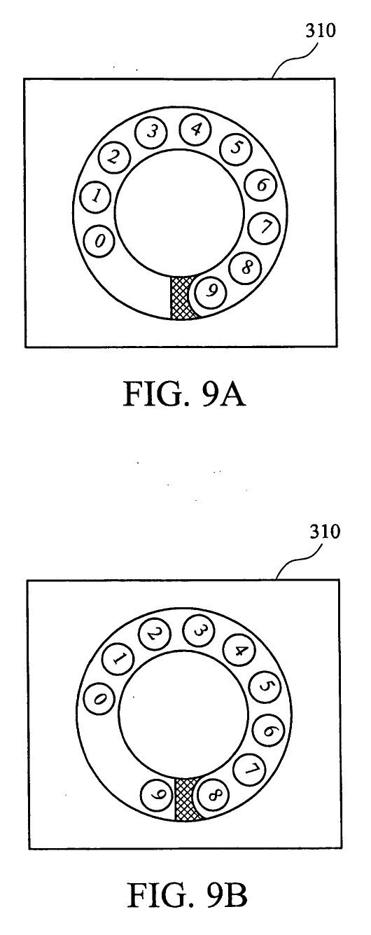

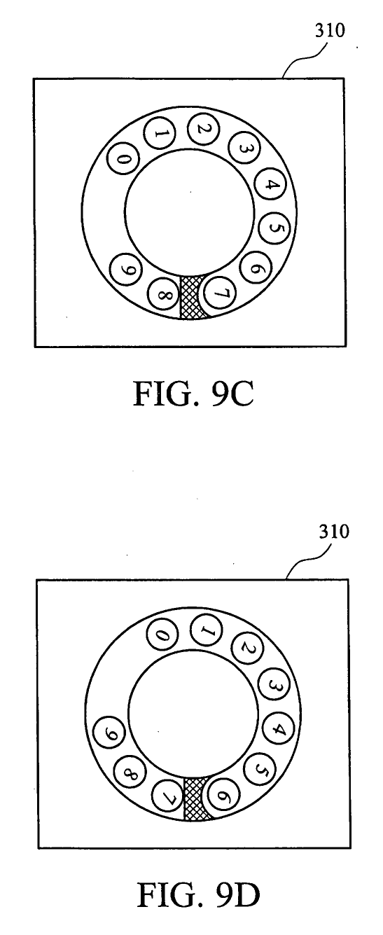

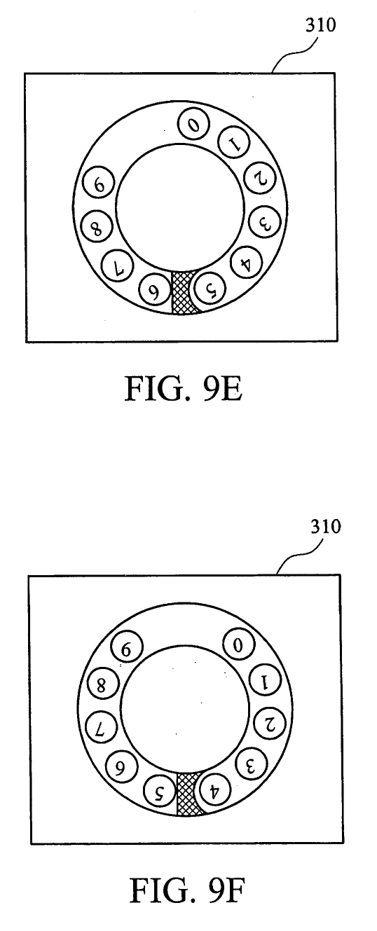

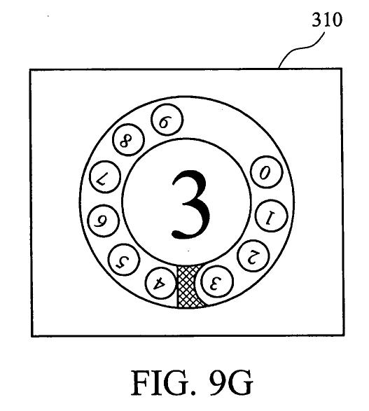

Some examples are described below. When a user intends to input number “3” to the portable device 300, the user may first use his/her finger to contact the specific zone Z3 corresponding to number “3” on the touch-sensitive element 320, as shown in FIG. 8A, where CP is the contact position of the finger. Then, the user slides his/her finger to the specific position SP of the touch-sensitive element 320 along a predefined route as indicated by the arrow in FIG. 8A. When the finger reaches the specific position SP, number “3” displayed on the display unit 310 also reaches the positional notation SR simultaneously, thereby selecting number “3” corresponding to the specific zone Z3. Thereafter, the finger leaves the surface of the touch-sensitive element 320 such that the selected number “3” is automatically input and highlighted on the display unit 310, as shown in FIG. 8B. In this example, number “3” corresponding to the specific zone Z3 is highlighted on the display unit 310 with a magnified character as compared to other non-selected numbers “0”, “1”, “2”, “4”, “5”, “6”, “7”, “8”, and “9”; however, various manners, such as character reduction, twinkling, coloring etc., can also be used to highlight the selected number. In this example, when the finger slides from the specific zone Z3 to the specific position SP along the predefined route, the numbers displayed on the display unit 310 move correspondingly, as shown in FIG. 9A to FIG. 9G.

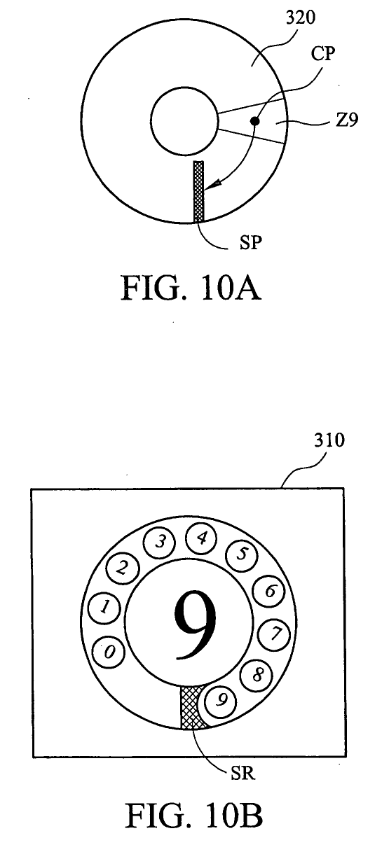

Similarly, when a user intends to input number “9” to the portable device 300, the user may first use his/her finger to contact the specific zone Z9 corresponding to number “9” on the touch-sensitive element 320, as shown in FIG. 10A. Then, the user slides his/her finger to the specific position SP of the touch-sensitive element 320 along a predefined route as indicated by the arrow in FIG. 10A. When the finger reaches the specific position SP, number “9” displayed on the display unit 310 also reaches the positional notation SR simultaneously, thereby selecting number “9” corresponding to the specific zone Z9. Thereafter, the finger leaves the surface of the touch-sensitive element 320 such that the selected number “9” is automatically input and highlighted on the display unit 310, as shown in FIG. 10B.

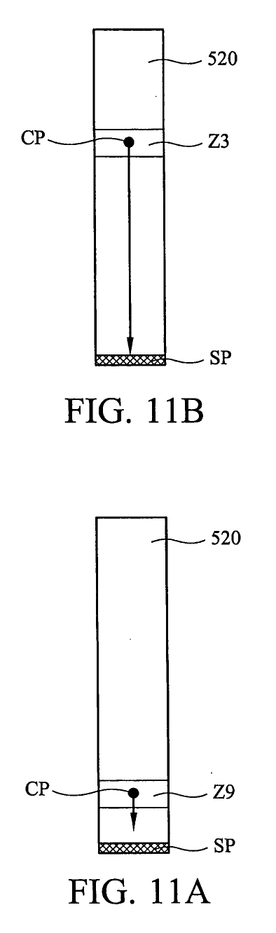

When a user intends to input number “3” to the portable device 500, the user may first use his/her finger to contact the specific zone Z3 corresponding to number “3” on the touch-sensitive element 520, as shown in FIG. 11A. Then, the user slides his/her finger to the specific position SP of the touch-sensitive element 520 along a predefined route as indicated by the arrow in FIG. 11A. When the finger reaches the specific position SP, number “3” displayed on the display unit 510 also reaches the positional notation SR simultaneously, thereby selecting number “3” corresponding to the specific zone Z3. Thereafter, the finger leaves the surface of the touch-sensitive element 520 such that the selected number “3” is automatically input and highlighted on the display unit 510, as shown in FIG. 8B.

In another example, when a user intends to input number “9” to the portable device 500, the user may first use his/her finger to contact the specific zone Z9 corresponding to number “9” on the touch-sensitive element 520, as shown in FIG. 11B. Then, the user slides his/her finger to the specific position SP of the touch-sensitive element 520 along a predefined route as indicated by the arrow in FIG. 11B. When the finger reaches the specific position SP, number “9” displayed on the display unit 510 also reaches the positional notation SR simultaneously, thereby selecting number “9” corresponding to the specific zone Z9. Thereafter, the finger leaves the surface of the touch-sensitive element 520 such that the selected number “9” is automatically input and highlighted on the display unit 510, as shown in FIG. 10B. Similarly, when the contact remains and slides on the touch-sensitive element 520, the numbers displayed on the display unit 510 move along the specific route according to the sliding direction of the contact.

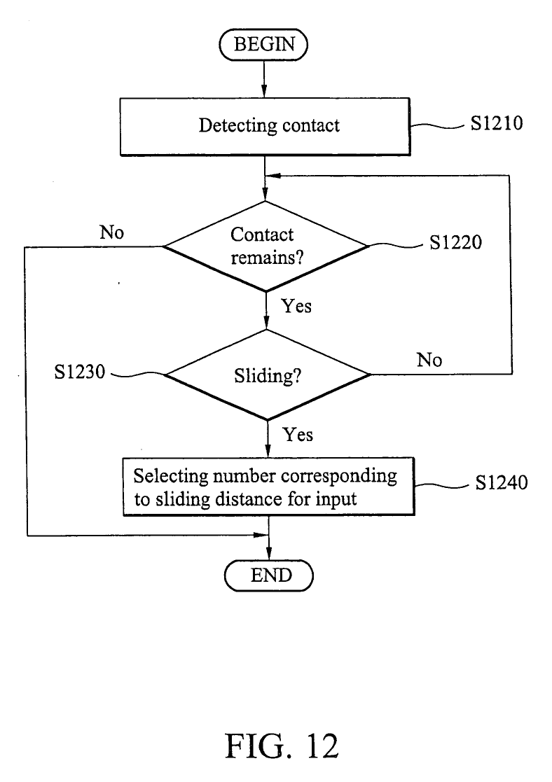

FIG. 12 is a flowchart for illustrating an input method according to other embodiment of the present invention. In this embodiment, the touch-sensitive element has no specific zones and specific position defined thereon. Users can use a pointer such as finger or stylus to contact any position of the touch-sensitive element and slide thereon, thus selecting a number according to the sliding distance of the pointer for input.

Firstly, in step S1210, a contact of a pointer such as finger or stylus on the touch-sensitive element is detected. It is noted that the detection of a pointer contact may be triggered by contacting any position of the touch-sensitive element or contacting any position of the touch-sensitive element for a predetermined period. In step S1220, it is determined whether the contact of the pointer remains on the surface of the touch-sensitive element. If the contact does not remain, that is, if the pointer leaves the surface of the touch-sensitive element, the input procedure ends. If the contact remains, it is determined whether the pointer slides in step S1230. If the pointer does not slide, the input procedure returns to step S1220. If the pointer slides, a specific number is selected according to the sliding distance of the pointer for input in step S1240. It is understood that each number corresponds to a predefined sliding distance or a predefined sliding distance with upper and lower thresholds. For example, the predefined sliding distance for number “3” may be 3 cm, and the upper and lower thresholds are 2.5 and 3.5 cm, respectively. If the sliding distance of the pointer is 2.8 cm, number “3” is selected for input.

It is understood that, in some embodiments, when the pointer stops contacting the touch-sensitive element or leaves the surface of the touch-sensitive element, the sliding of the pointer is complete and the number corresponding to the sliding distance is input and highlighted on the display unit. Further, the display unit can also display a graphic interface corresponding to the touch-sensitive element, as shown in FIG. 4.

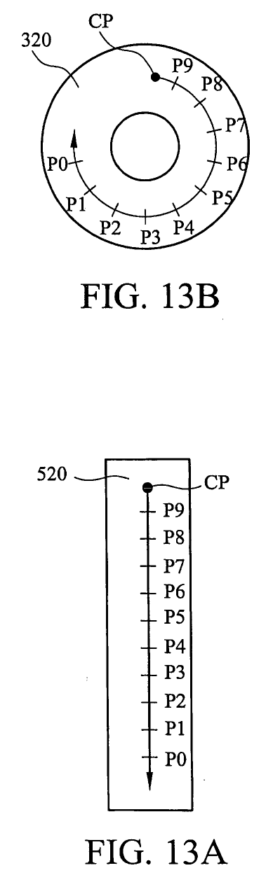

FIG. 13A shows a schematic diagram of a rotational touch-sensitive element according to one embodiment of the present invention for illustrating a relationship between a sliding distance and a specific number. In this embodiment, when the pointer slides from contact position CP to P0 on the touch-sensitive element 320, number “0” is input. When the pointer slides from contact position CP to P1 on the touch-sensitive element 320, number “1” is input. When the pointer slides from contact position CP to P2 on the touch-sensitive element 320, number “2” is input. When the pointer slides from contact position CP to P3 on the touch-sensitive element 320, number “3” is input. When the pointer slides from contact position CP to P4 on the touch-sensitive element 320, number “4” is input. When the pointer slides from contact position CP to P5 on the touch-sensitive element 320, number “5” is input. When the pointer slides from contact position CP to P6 on the touch-sensitive element 320, number “6” is input. When the pointer slides from contact position CP to P7 on the touch-sensitive element 320, number “7” is input. When the pointer slides from contact position CP to P8 on the touch-sensitive element 320, number “8” is input. When the pointer slides from contact position CP to P9 on the touch-sensitive element 320, number “9” is input. Similarly, when the contact remains and slides on the touch-sensitive element 320, the numbers displayed on the display unit 310 move along the specific route according to the sliding direction of the contact.

FIG. 13B shows a schematic diagram of a vertical touch-sensitive element according to other embodiment of the present invention for illustrating a relationship between a sliding distance and a specific number. In this embodiment, the input behavior of the touch-sensitive element 520 is similar to that of the touch-sensitive element 320 in FIG. 13A except that the specific routes on the touch-sensitive elements 320 and 520 are different. The specific route on the touch-sensitive element 320 is an arc route as shown in FIG. 13A, and the specific route on the touch-sensitive element 520 is a straight route as shown in FIG. 13B. For example, when the pointer slides from contact position CP downward to P0 on the touch-sensitive element 520, number “0” is input. When the pointer slides from contact position CP downward to P9 on the touch-sensitive element 520, number “9” is input. Similarly, when the contact remains and slides on the touch-sensitive element 520, the numbers displayed on the display unit 510 move along the specific route according to the sliding direction of the contact.

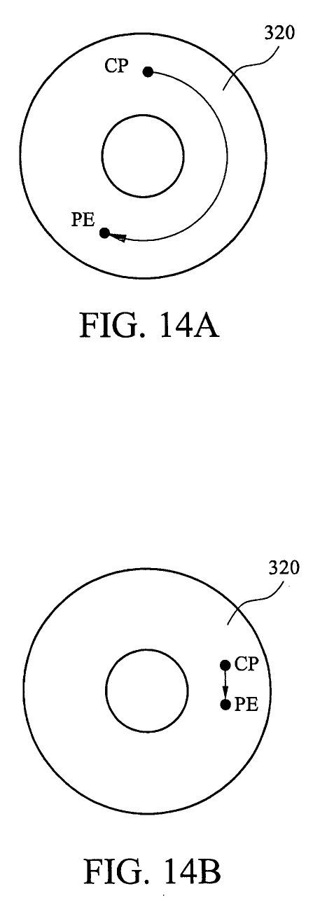

Some examples are described below. When a user intends to input number “3” to the portable device 300, the user may first use his/her finger to contact any position on the touch-sensitive element 320, where CP is the contact position of the finger. Then, the user slides his/her finger to a position PE on the touch-sensitive element 320 as shown in FIG. 14A such that number “3” displayed on the display unit 310 moves to the positional notation SR simultaneously and is selected for input, where the sliding distance from CP to PE is equal to that from CP to P3 in FIG. 13A. Thereafter, the finger leaves the surface of the touch-sensitive element 320 from the position PE such that the number “3” is automatically input and highlighted on the display unit 310, as shown in FIG. 8B.

Similarly, when a user intends to input number “9” to the portable device 300, the user may first use his/her finger to contact any position on the touch-sensitive element 320, where CP is the contact position of the finger. Then, the user slides his/her finger to a position PE on the touch-sensitive element 320 as shown in FIG. 14B such that number “9” displayed on the display unit 310 moves to the positional notation SR simultaneously and is selected for input, where the sliding distance from CP to PE is equal to that from CP to P9 in FIG. 13A. Thereafter, the finger leaves the surface of the touch-sensitive element 320 from the position PE such that the number “9” is automatically input and highlighted on the display unit 310, as shown in FIG. 10B.

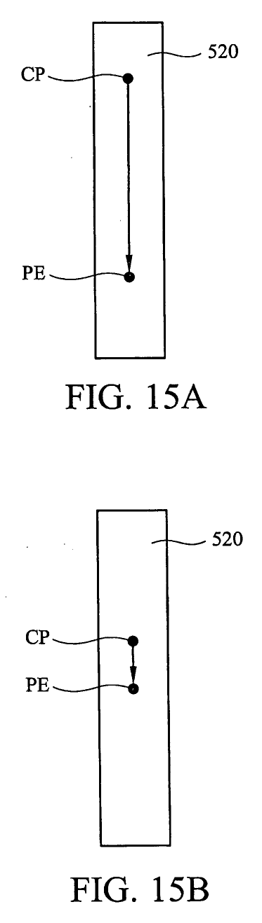

When a user intends to input number “3” to the portable device 500, the user may first use his/her finger to contact any position on the touch-sensitive element 520, where CP is the contact position of the finger. Then, the user slides his/her finger to a position PE on the touch-sensitive element 520 as shown in FIG. 15A such that number “3” displayed on the display unit 510 moves to the positional notation SR simultaneously and is selected for input, where the sliding distance from CP to PE is equal to that from CP to P3 in FIG. 13B. Thereafter, the finger leaves the surface of the touch-sensitive element 520 from the position PE such that the number “3” is automatically input and highlighted on the display unit 510, as shown in FIG. 8B.

Similarly, when a user intends to input number “9” to the portable device 500, the user may first use his/her finger to contact any position on the touch-sensitive element 520, where CP is the contact position of the finger. Then, the user slides his/her finger to a position PE on the touch-sensitive element 520 as shown in FIG. 15B such that number “9” displayed on the display unit 510 moves to the positional notation SR simultaneously and is selected for input, where the sliding distance from CP to PE is equal to that from CP to P9 in FIG. 13B. Thereafter, the finger leaves the surface of the touch-sensitive element 520 from the position PE such that the number “9” is automatically input and highlighted on the display unit 510, as shown in FIG. 10B.

It is understood that the procedure for inputting a specific number may be repeated until a partial or complete phone number is input. The input number can be used to query related address books or other applications, and/or make a call accordingly by pressing a dial key (not shown).

Input methods of the present invention, or certain types or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods of the present invention. The methods of the present invention may also be embodied in the form of program code transmitted via some transmission medium, such as electrical wiring or cables, fiber optics, or any other forms of transmission, wherein, when the program code is received, loaded into and executed by a machine, such as a computer, the machine becomes an apparatus for practicing the disclosed methods. When the program code is implemented on a general-purpose processor, the program code together with the processor can form a unique device that operates as a device with specific logic circuits.

While the invention has been described by way of example and in terms of embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An input method for an electronic device having a touch-sensitive element and a display unit, comprising:
detecting a contact on a specific zone of the touch-sensitive element;
determining whether the contact remains; and
if the contact remains and slides to a specific position of the touch-sensitive element, selecting a specific number corresponding to the specific zone for input.

2. The method of claim 1, further comprising inputting the specific number when the contact on the touch-sensitive element finishes.

3. The method of claim 1, further comprising displaying a plurality of numbers on the display unit, wherein the numbers are arranged along a specific route in sequence, and the specific number is one of the numbers.

4. The method of claim 3, further comprising moving the numbers displayed on the display unit according to a sliding direction of the contact along the specific route during the sliding of the contact on the touch-sensitive element.

5. The method of claim 1, further comprising highlighting the specific number in the display unit when the contact remains and slides to the specific position of the touch-sensitive element.

6. An input method for an electronic device having a touch-sensitive element and a display unit, comprising:
detecting a contact on the touch-sensitive element;
determining whether the contact remains; and
when the contact remains and slides for a specific distance, selecting a specific number corresponding to the specific distance for input.

7. The method of claim 6, further comprising inputting the specific number when the contact on the touch-sensitive element finishes.

8. The method of claim 6, further comprising displaying a plurality of numbers on the display unit, wherein the numbers are arranged along a specific route in sequence, and the specific number is one of the numbers.

9. The method of claim 8, further comprising moving the numbers displayed on the display unit according to a sliding direction of the contact along the specific route during the sliding of the contact on the touch-sensitive element.

10. The method of claim 6, further comprising highlighting the specific number in the display unit when the contact remains and slides for the specific distance on the touch-sensitive element.

11. The method of claim 6, wherein the touch-sensitive element has a touch-sensitive surface, and the contact is at any position on the circular touch-sensitive surface.

12. An electronic device, comprising:
a display unit displaying a plurality numbers; and
a touch-sensitive element having a touch-sensitive surface defining a plurality of specific zones and a specific position thereon, wherein each specific zone corresponds to one of the numbers;
wherein when a contact occurs on one of the specific zones and slides to the specific position, the number corresponding to the specific zone with the occurrence of the contact is highlighted in the display unit.

13. The electronic device of claim 12, wherein the numbers are arranged along a specific route in sequence.

14. The electronic device of claim 13, wherein the numbers displayed on the display unit move according to a sliding direction of the contact along the specific route during the sliding of the contact on the touch-sensitive element.

15. The electronic device of claim 12, wherein the touch-sensitive surface comprises a circular touch-sensitive surface.

16. The electronic device of claim 12, wherein the touch-sensitive surface comprises an elongated touch-sensitive surface.

17. An electronic device, comprising:
a display unit displaying a plurality of numbers; and
a touch-sensitive element having a touch-sensitive surface,
wherein when a contact occurs on the touch-sensitive surface and slides for a specific distance, one of the numbers is highlighted in the display unit according to the specific distance.

18. The electronic device of claim 17, wherein the numbers are arranged along a specific route in sequence.

19. The electronic device of claim 18, wherein the numbers displayed on the display unit move according to a sliding direction of the contact along the specific route during the sliding of the contact on the touch-sensitive element.

20. The electronic device of claim 17, wherein the contact is at any position on the touch-sensitive surface.
